(19) United States
(12) Patent Application Publication
(10) Pub. No.: US 2026/0363944 A1
(43) Pub. Date: Nov. 19, 2026

(54) HIGH-SAFETY MULTIFUNCTIONAL ROLLING MASSAGER

(71) Applicant: MAYBEDEALS LLC, Ypsilanti, MI (US)

(72) Inventor: Binbin LI, Fujian Province (CN)

(21) Appl. No.: 19/455,609

(22) Filed: Jan. 21, 2026

(30) Foreign Application Priority Data
May 16, 2025 (CN) 202520981487.X

(51) Int. Cl. A61H 15/00

(52) U.S. Cl. CPC A61H 15/0085; A61H 2201/0176; A61H 2201/5064

(57) ABSTRACT

A rolling massager having a rod-shaped massager that has a massage bracket, a massage head assembly, a drive motor, and at least one sensing device; a gripping portion of at least one of the two handles configured on the massage bracket has a sensing element of a respective sensing device; The sensing element of each sensing device can trigger the drive motor to operate when a touch of a human hand is detected, and to trigger the drive motor to stop when no touch of the human hand is detected. Therefore, the massage has enhanced safety of use.

### TECHNICAL FIELD

The present invention relates to the technical field of massage equipment, and in particular, to a high-safety multifunctional rolling massager.

### BACKGROUND OF THE INVENTION

Massage is the act of rubbing, kneading, or tapping surfaces of the body using hands or devices for medical treatment and general health care. The application of a massage device to a surface of a specific part of the body can regulate the body's physiological and pathological conditions, thereby achieving the purpose of physical therapy and recovery. In essence, massage is a kind of physical therapy.

There are various types of massage devices available in the market, including hand-operated massage devices, such as hand-operated massage rollers, as well as electric massage devices. However, most of the electric massage devices such as massage chairs, shoulder-mounted massagers and backrest massagers can only perform localized massages.

Conventional hand-operated massage rollers are handheld by users and allow rolling massage to any part of a user's body, thus not limited to localized areas. However, manual massage is labor-intensive and can cause fatigue of the hands. For example, CN221770763U discloses a rolling multifunctional massage device that uses a motor to drive circumferentially arranged massage heads to perform massage, making it more effortless and providing better massage effects, as well as being able to adapt to various body curves by rolling on different body parts that require massage. However, existing handheld massage devices usually require pressing a button switch to control on/off of the rolling of the massage heads, and the plurality of circumferentially arranged massage heads present the risk of accidentally pinching user's fingers or other body parts, or entangling the user's hair. Therefore, if an accident occurs during massage, the user needs to press the switch button before the massage heads stop rolling, meaning that the massage heads may not be stopped in time in case of accident. Therefore, it is still inconvenient to use such massage devices.

### BRIEF SUMMARY OF THE INVENTION

It is an object of the present invention to provide a high-safety multifunctional rolling massager, which has the advantage of quick stoppage of massage in case of accidents, so that the massager has an increased safety of use.

To achieve the above object, the present invention provides the following technical solutions:

A rolling massager, comprising a rod-shaped massager; the rod-shaped massager comprises a massage bracket, a massage head assembly, a drive motor, and at least one sensing device;

two handles are provided at a left side and a right side of the massage bracket respectively, and a connecting post is disposed between the two handles and connects the two handles;

the massage head assembly comprises two side covers at a left side and a right side of the massage head assembly respectively, and a plurality of connecting shafts; the two side covers rotatably sleeve an outside of the connecting post; two ends of each of the plurality of connecting shafts are connected to the two side covers respectively; each of the plurality of connecting shafts is sleeved by a respective one of a plurality of massage heads; the plurality of connecting shafts and the plurality of massage heads thereon are circumferentially arranged around a circumference of the connecting post and spaced apart from one another; each of the plurality of massage heads is rotatable around a respective connecting shaft;

an inner circumferential surface of one of the two side covers of the massage head assembly is provided with internal gear teeth; an output end of the drive motor is provided with a reduction gear box; the reduction gear box drives said one of the two side covers containing the internal gear teeth to rotate via a gear transmission assembly, so that the plurality of massage heads revolve around the connecting post;

each sensing device comprises a sensing element and a circuit board electrically connected to each other; at least one of the two handles is provided with a respective one of said at least one sensing devices; the circuit board is also electrically connected to the drive motor.

Further, the sensing element is a sensing wire; the circuit board is provided with a touch chip; the touch chip is configured to detect capacitance change of the sensing wire; each of the two handles is provided with a respective sensing device such that there are two sensing devices.

Further, an outer side of each of the two handles away from the massage head assembly is shaped to form a gripping portion having a U-shape; the sensing element of each of the two sensing devices is arranged on an inner wall of the gripping portion of a respective one of the two handles.

Further, the rolling massager also comprises a support seat; a left side and a right side of the support seat are raised platforms respectively; each of the raised platforms is provided with a handle slot wherein a respective one of the two handles of the massage bracket is placed; in between the raised platforms is an operation area in which the massage head assembly is positioned and rotates therein; at least one of the raised platforms corresponding to said at least one of the two handles provided with the respective one of said at least one sensing devices is provided with a magnet, and said at least one of the two handles provided with the respective one of said at least one sensing devices is also provided with at least one Hall sensor; said at least one Hall sensor is electrically connected to the circuit board; when the rod-shaped massager is placed on the support seat, the magnet is placed proximal to said at least one Hall sensor and thus triggers said at least one Hall sensor.

Further, each of the raised platforms is provided with said magnet.

Further, a battery electrically connected to the drive motor is provided inside the connecting post; an inner side of an end of said at least one of the two handles provided with the respective one of said at least one sensing devices is provided with the circuit board, on which a charging connector electrically connected to the battery is installed; on the circuit board, two of said at least one Hall sensor are installed above and below the charging connector respectively, so that there are two Hall sensors; the charging connector is provided with a charging port exposed at a middle part of an end surface of a respective one of the two handles provided with the charging connector; a height of a slot wall of the handle slot of a respective one of the raised platforms corresponding to the respective one of the two handles provided with the charging connector does not exceed a bottom side of the charging port, and the magnet is installed inside the slot wall of the handle slot of the respective one of the raised platforms.

Further, one of said at least one of the two handles provided with the respective one of said at least one sensing devices is also provided with an adjustment board electrically connected to the circuit board of said respective one of said at least one sensing devices; the adjustment board is provided with a power switch and an adjustment switch.

Further, the connecting post is provided with an installation space, in which the drive motor is installed; the drive motor drives said one of the two side covers containing the internal gear teeth to rotate, thereby driving the massage head assembly to rotate.

Further, the installation space is also provided with the gear transmission assembly, which comprises a drive gear and two transmission gears; the drive gear is coaxially connected to an output end of the reduction gear box; the two transmission gears are symmetrically meshed with two sides of the drive gear, and the two transmission gears partially extend out of two side wall openings of the installation space respectively to mesh with the internal gear teeth of said one of the two side covers containing the internal gear teeth.

Further, one end of the connecting post is integrally connected to one of the two handles, and another end of the connecting post is detachably connected to a connecting rotating shaft and a handle reinforcing member; the handle reinforcing member is configured to install another one of the two handles; the connecting rotating shaft is hollow.

According to the technical solutions given above, the present invention provides said at least one sensing device and the sensing element of each sensing device in the gripping portion of each of the two handles having the respective one of said at least one sensing devices, and configures the sensing element of each sensing device to trigger the drive motor to operate when a touch of a human hand is detected, and to trigger the drive motor to stop when no touch of the human hand is detected. Accordingly, when the user holds the two handles, in particular two gripping portions of the two handles, the drive motor is activated to drive the plurality of massage heads to roll (revolve around the connecting post) for massage. During use, when the plurality of massage heads accidentally pinch parts of the body or entangle hair of the user, the user only needs to free the hands from holding the two handles, and the drive motor can then stop running, causing the plurality of massage heads to stop revolving, thereby avoiding further injury to the user and improving safety during massage.

### BRIEF DESCRIPTION OF THE DRAWINGS

FIG. 1 is a perspective view of an embodiment of the present invention;

FIG. 2 is an exploded view of an embodiment of the present invention;

FIG. 3 is a side view of an embodiment of the present invention;

FIG. 4 is a sectional view taken along line A-A of FIG. 3;

FIG. 5 is a sectional view taken along line B-B of FIG. 3;

FIG. 6 is an enlarged view of area C in FIG. 4;

FIG. 7 is an exploded view of the rod-shaped massager according to an embodiment of the present invention;

FIG. 8 is a partially exploded view of the massage head assembly according to an embodiment of the present invention;

FIG. 9 is a perspective view of the sensing device according to an embodiment of the present invention.

Reference Numerals:
Rod-shaped massager 1,
massage bracket 11,
handle 111,
gripping portion 1111,
inner wall 1112,
connecting post 112,
installation space 1121,
side wall opening 1122,
connecting rotating shaft 113,
handle reinforcing member 114,
massage head assembly 12,
massage head 121,
side cover 122,
internal gear teeth 1221,
connecting shaft 123,
drive motor 13,
reduction gear box 131,
sensing device 14,
sensing element 141,
circuit board 142,
touch chip 1421, battery 15,
charging connector 16,
charging port 161,
adjustment board 17,
power switch 171,
adjustment switch 172,
gear transmission assembly 18,
drive gear 181,
transmission gear 182,
support seat 2,
raised platform 21,
handle slot 211,
slot wall 2111,
operation area 22,
magnet 3,
Hall sensor 4.

### DETAILED DESCRIPTION OF THE INVENTION

To make the objectives, technical solutions, and advantages of this application clearer, the technical solutions in the embodiments of the present invention will be described clearly and thoroughly below with reference to the accompanying drawings. Obviously, the described embodiments are only some but not all of the embodiments of the present invention. The components of the embodiments of the present invention as described and shown in the accompanying drawings can be arranged and designed in various different configurations.

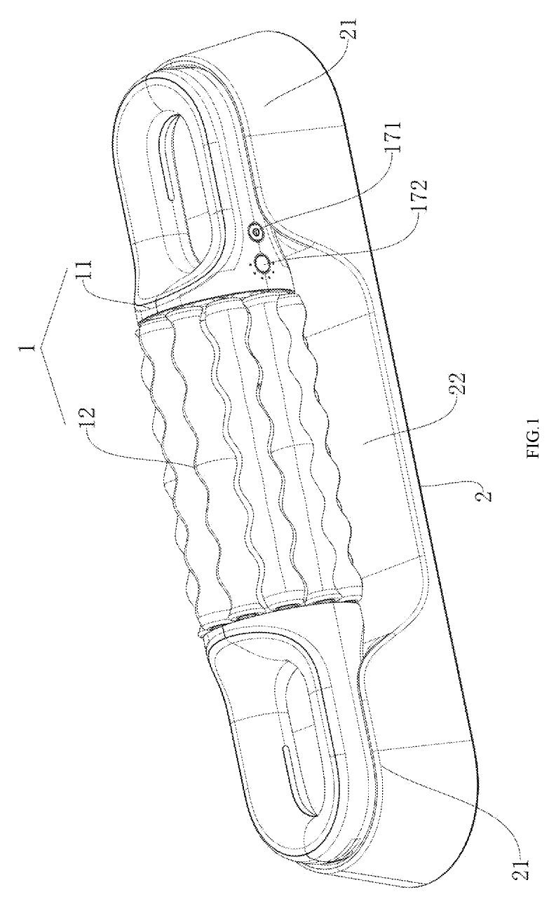

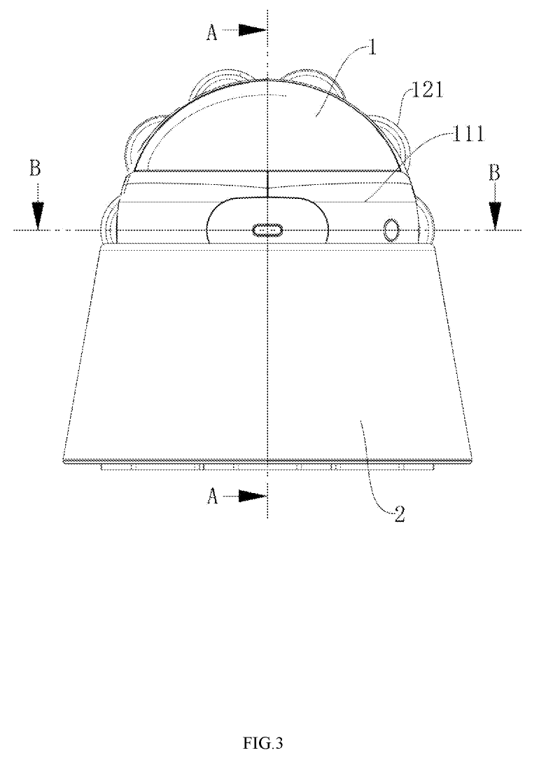

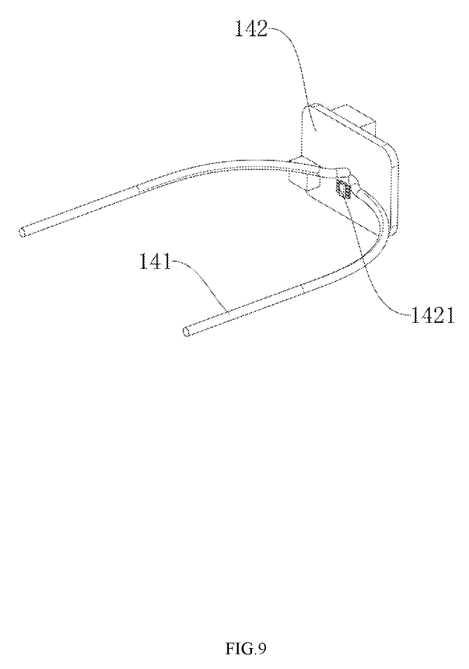

As shown in FIGS. 1-9, a high-safety multifunctional rolling massager according to the present embodiment comprises a rod-shaped massager 1. The rod-shaped massager 1 comprises a massage bracket 11, a massage head assembly 12, a drive motor 13, and at least one sensing device 14.

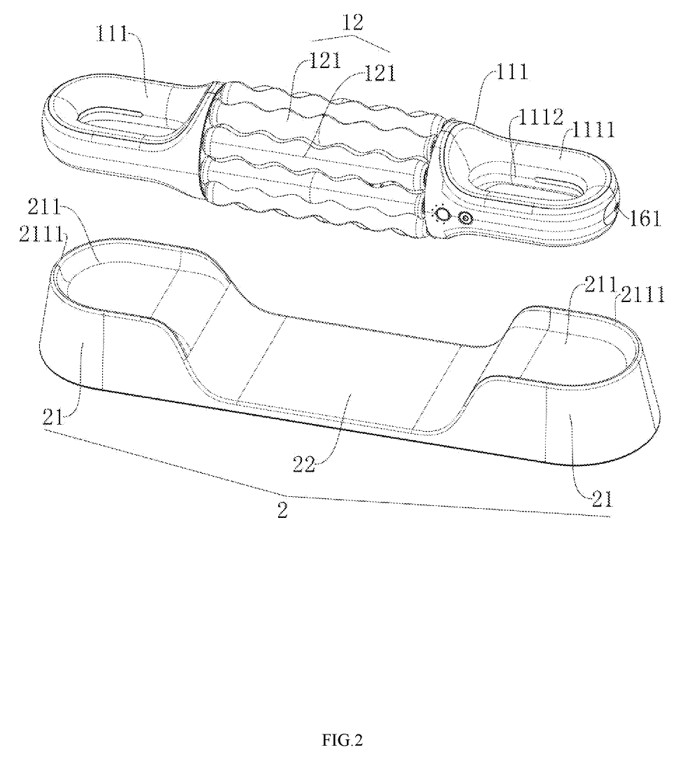

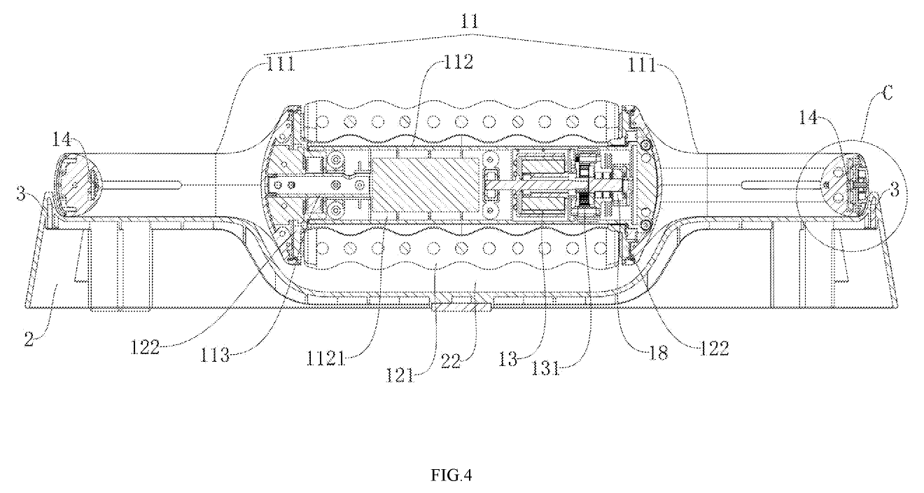

As shown in FIGS. 2 and 4, two handles 111 are provided at a left side and a right side of the massage bracket 11 respectively, and a connecting post 112 is disposed between the two handles 111 and connects the two handles 111. The massage head assembly 12 rotatably sleeves around an outer side of the connecting post 112; the massage head assembly 12 comprises a plurality of massage heads 121 circumferentially arranged around a circumference of the connecting post 112, and the plurality of massage heads 121 are spaced apart from one another. The plurality of massage heads 121 are driven by the drive motor 13 to revolve around the connecting post 112. Thus, by providing the plurality of massage heads 121 that can revolve around the connecting post 112 between the two handles 111, the user can conveniently hold the rod-shaped massager 1 to roll and relax muscles of various parts of the body.

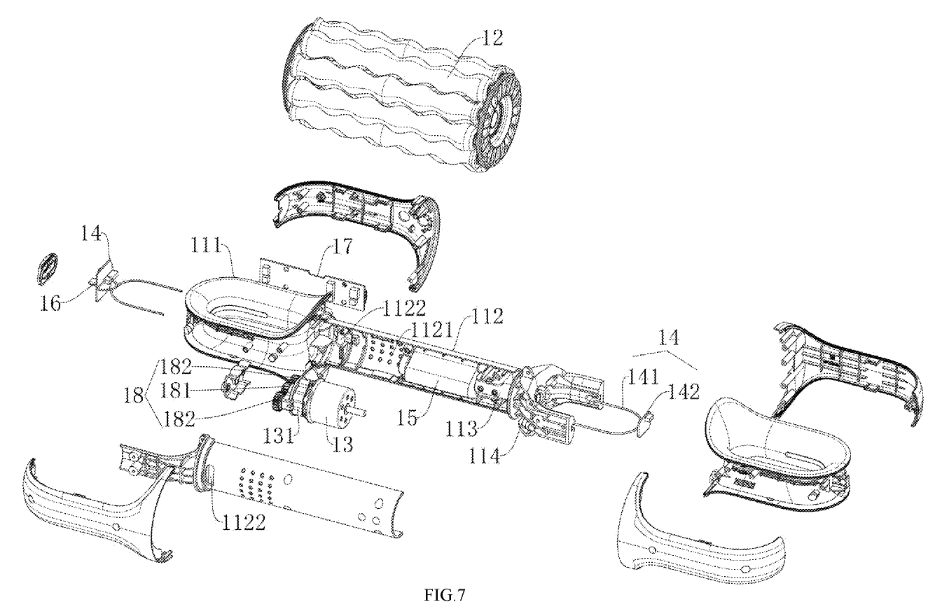

With reference to FIG. 7, each sensing device 14 comprises a sensing element 141 and a circuit board 142. At least one of the two handles 111 is provided with a respective one of said at least one sensing devices 14; a gripping portion 1111 of each of the two handles 111 having the respective one of said at least one sensing devices 14 is provided with the sensing element 141, and the circuit board 142 is electrically connected to the sensing element 141 and the drive motor 13. In this embodiment, by providing said at least one sensing device 14 and the sensing element 141 of each sensing device 14 in the gripping portion 1111 of each of the two handles 111 having the respective one of said at least one sensing devices 14, and by using existing circuit designs, the sensing element 141 and the circuit board 142 are connected to the drive motor 13, and the sensing element 141 of each sensing device 14 can be configured to trigger the drive motor 13 to operate when a touch of a human hand is detected, and to trigger the drive motor 13 to stop when no touch of the human hand is detected.

Thus, when the user holds the two handles 111, in particular two gripping portions 1111 of the two handles 111, the drive motor 13 is activated to drive the plurality of massage heads 121 to roll (revolve around the connecting post 112) for massage. During use, when the plurality of massage heads 121 accidentally pinch parts of the body or entangle hair of a user, the user only needs to free the hands from holding the two handles 111, and the drive motor 13 can then stop running, causing the plurality of massage heads 121 to stop revolving, thereby avoiding further injury to the user and improving safety during massage.

Specifically, the sensing element 141 can be a sensing wire, which can be arranged inside a housing of the gripping portion 1111 of each of the two handles 111 having the respective one of said at least one sensing devices 14. The circuit board 142 is provided with a touch chip 1421, which is configured to detect capacitance change of the sensing wire. Specifically, in this embodiment, when the gripping portion 1111 having the respective one of said at least one sensing device 14 is gripped, the sensing wire can sense the human body's capacitance through the housing of the gripping portion 1111, allowing the touch chip 1421 to identify a touch signal and therefore control operation of the drive motor 13 according to known techniques in the prior art.

In this embodiment, the sensing element 141 is described as a sensing wire, which has the advantages of low cost, simple and convenient installation, and a wide detection range. However, the sensing element 141 is not limited to this; the sensing wire can also be replaced with other metal parts such as copper foil, or replaced by a pressure sensor, infrared sensor, or sensing spring etc.

In this embodiment, each of the two handles 111 is provided with a respective one of said at least one sensing device 14 to improve the convenience of use since sensing is achieved by holding either one or both of the two handles 111.

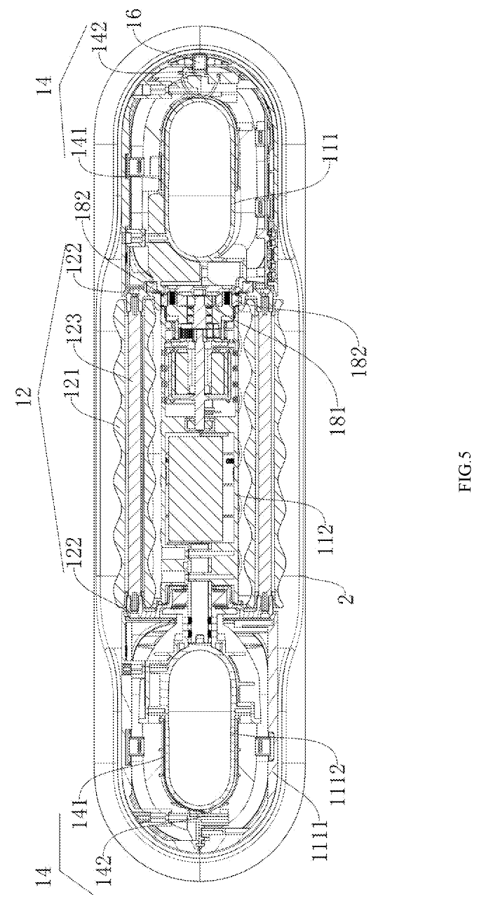

With reference to FIGS. 1 and 5, in this embodiment, an outer side of each of the two handles 111 away from the massage head assembly 12 is shaped to form the gripping portion 1111 having a U-shape; the sensing element 141 is arranged on an inner wall 1112 of the gripping portion 1111 having the respective one of said at least one sensing device 14, and the sensing element 141 can also be shaped substantially into a U-shape. In an embodiment where each of the two handles 111 is provided with a respective one of said at least one sensing device 14, it is ensured that when the user holds either one of the two handles 111, there is always contact with the sensing element 141, and by arranging the sensing element 141 on the inner wall 1112 of a respective gripping portion 1111, accidental triggering of the sensing function of the sensing element 141 can be avoided, thereby improving reliability in use.

Of course, each of the two handles 111 can also be cylindrical. An exact shape of each of the two handles 111 should not be limited to the embodiments described above.

As shown in FIGS. 2 and 4, in this embodiment, the multifunctional rolling massager also comprises a support seat 2, which allows the rod-shaped massager 1 to rest on during use for effort saving.

Specifically, a left side and a right side of the support seat 2 are raised platforms 21 respectively; each of the raised platforms 21 is provided with a handle slot 211 for placing a respective one of the two handles 111 of the massage bracket 11. In between the raised platforms 21 is an operation area 22 in which the massage head assembly 12 is positioned and rotates therein. Thus, after the two handles 111 of the rod-shaped massager 1 are rested on the raised platforms 21, the user can place their legs or feet on the massage head assembly 12 in the operation area 22 for massage.

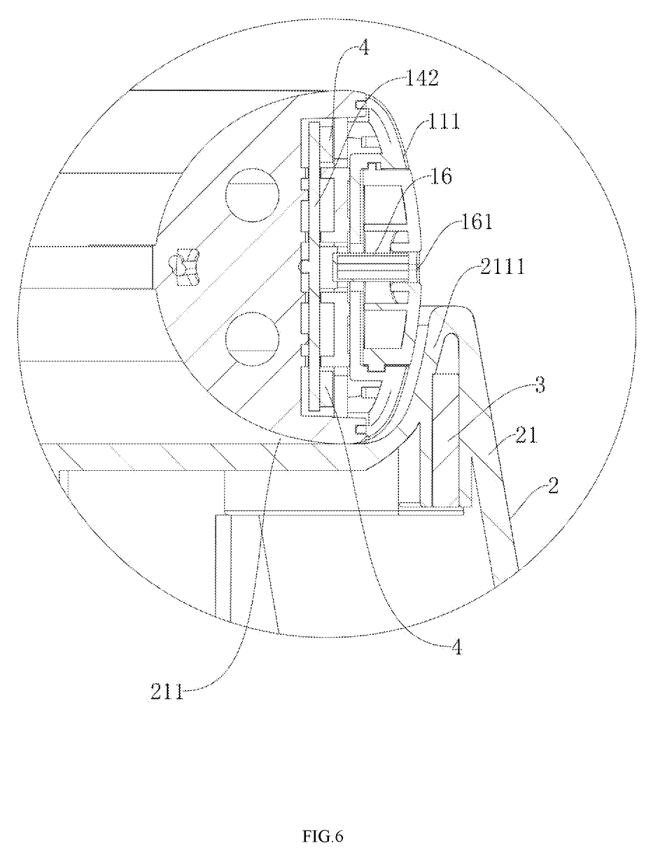

With reference to FIG. 6, in this embodiment, at least one of the raised platforms 21 corresponding to said at least one of the two handles 111 provided with the respective one of said at least one sensing devices 14 is provided with a magnet 3, and said at least one of the two handles 111 provided with the respective one of said at least one sensing devices 14 is also provided with at least one Hall sensor 4; said at least one Hall sensor 4 is electrically connected to the circuit board 142. When the rod-shaped massager 1 is placed on the support seat 2, the magnet 3 can approach and trigger said at least one Hall sensor 4.

Therefore, when the rod-shaped massager 1 is placed on the support seat 2, the sensing element 141 is away from the user’s hand, and the drive motor 13 stops. However, since said at least one Hall sensor 4 is triggered by the magnet 3 and said at least one Hall sensor 4 can be prioritized over the sensing element, the drive motor 13 is being driven to continue rotating even when there is no hand contact. Thus, when the rod-shaped massager 1 is placed on the support seat 2, the plurality of massage heads 121 can continue to revolve, thereby enabling convenient and effect-saving massage operation.

Specifically, each of the raised platforms 21 is provided with the magnet 3 such that there are two magnets 3 in total (correspondingly, each of the two handles 111 should also be provided with a respective one of said at least one sensing device 14). As such, each of the two handles 111 can correspond to either one of the raised platforms 21, thereby improving convenience of use.

Further, with reference to FIG. 7, in this embodiment, a battery 15 electrically connected to the drive motor 13 is provided inside the connecting post 112, enabling portable massage operation. Of course, the present invention shall not be limited by such embodiment, for example, the drive motor 13 can also be powered by a power cord (not shown in the figures).

Furthermore, as shown in FIG. 6, an inner side of an end of one of the two handles 111 is provided with the circuit board 142, on which a charging connector 16 electrically connected to the battery 15 is installed for convenient charging of the battery 15.

On the circuit board 142, two of said at least one Hall sensor 4 are installed above and below the charging connector 16 respectively, so that there are two Hall sensors 4; the charging connector 16 is provided with a charging port 161 exposed at a middle part of an end surface of a respective one of the two handles 111 provided with the charging connector 16. A height of a slot wall 2111 of the handle slot 211 of a respective one of the raised platforms 21 corresponding to the respective one of the two handles 111 provided with the charging connector 16 does not exceed a bottom side of the charging port 161, and the magnet 3 is installed inside the slot wall 2111 of the handle slot 211 of the respective one of the raised platforms 21. Thus, when the rod-shaped massager 1 is placed on the support seat 2, a charging cable (not shown in the figures) can be directly connected for charging. The two Hall sensors 4 disposed above and below the charging connector 16 respectively allow the two handles 11 of the rod-shaped massager 1 to be placed facing up or facing down without affecting use of the rod-shaped massager 1, thereby effectively improving convenience.

As shown in FIGS. 1 and 7, in this embodiment, one of said at least one of the two handles 111 provided with the respective one of said at least one sensing devices 14 is also provided with an adjustment board 17 electrically connected to the circuit board 142 of said respective one of said at least one sensing devices 14. The adjustment board 17 is provided with a power switch 171 and an adjustment switch 172. The power switch 171 can control whether each sensing element 141 and each Hall sensor 4 are operating or not, and the adjustment switch 172 may be configured to adjust speeds of the plurality of massage heads 121. An actual function of the adjustment switch 172 can be configured as needed.

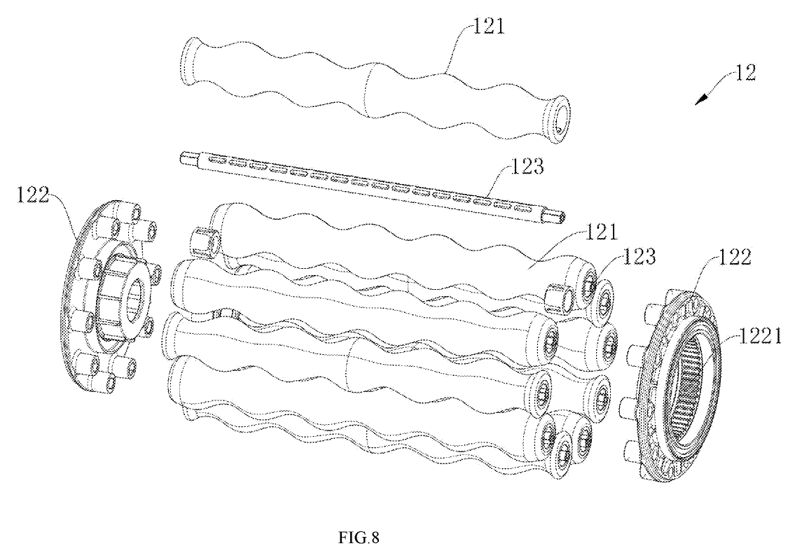

As shown in FIG. 8, the massage head assembly 12 comprises two side covers 122 at a left side and a right side of the massage head assembly 12 respectively, and a plurality of connecting shafts 123. The two side covers 122 rotatably sleeve an outside of the connecting post 112. Two ends of each of the plurality of connecting shafts 123 are connected to the two side covers 122 respectively, and the plurality of connecting shafts 123 are circumferentially arranged around the circumference of the connecting post 112, and the plurality of connecting shafts 123 are spaced apart from one another. Each of the plurality of connecting shafts 123 is sleeved by a respective one of the plurality of massage heads 121; each of the plurality of massage heads 121 is rotatable around a respective connecting shaft 123, thereby improving the massage effect.

The connecting post 112 is provided with an installation space 1121, in which the drive motor 13 is installed. The drive motor 13 drives one of the side covers 122 to rotate, thereby driving the massage head assembly 12 to rotate. The drive motor 13 is arranged in a middle part of the rod-shaped massager 1 to balance a center of gravity of the rod-shaped massager and to improve convenience and tactile comfortability during use.

Specifically, with reference to FIGS. 7 and 8, an inner circumferential surface of one of the side covers 122 of the massage head assembly 12 is provided with internal gear teeth 1221. The installation space 1121 is also provided with a gear transmission assembly 18, which comprises a drive gear 181 and two transmission gears 182. An output end of the drive motor 13 is provided with a reduction gear box 131. The drive gear 181 is coaxially connected to an output end of the reduction gear box 131. The two transmission gears 182 are symmetrically meshed with two sides of the drive gear 181, and the two transmission gears 182 partially extend out of two side wall openings 1122 of the installation space 1121 respectively to mesh with the internal gear teeth 1221 of the respective one of the side covers 122. By providing a planetary gear assembly, motion transmission efficiency and massage effect can be improved.

In this embodiment, one end of the connecting post 112 is integrally connected to one of the two handles 111, and another end of the connecting post 112 is detachably connected to a connecting rotating shaft 113 and a handle reinforcing member 114 to facilitate installation and assembly of the massage head assembly 12. The handle reinforcing member 114 has a middle connecting portion, a left connecting portion, and a right connecting portion; the left connecting portion and the right connecting portion are disposed at two ends of one side of the middle connecting portion respectively such that the middle connecting portion, the left connecting portion, and the right connecting portion form a U-shaped structure; another side of the middle connecting portion is connected to the connecting rotating shaft 113; the left connecting portion and the right connecting portion of the handle reinforcing member 114 are configured to install the another one of the two handles 111, thereby improving a structural strength of said another one of the two handles 111 and prolonging product life.

The connecting rotating shaft 113 can be hollow to facilitate wiring and allowing the sensing device 14 disposed inside said another one of the two handles 111 to be electrically connected via wires (not shown in the figures) to the adjustment board 17 inside said one of the two handles 111, preventing wire tangling and thus improving product reliability.

The above description is only a preferred embodiment of the present invention, and the scope of protection of the present invention is not limited to the above embodiments. Any technical solutions falling within the conceptual idea of the present invention shall be included in the scope of protection. It should be pointed out that for those skilled in the art, any changes and modifications achieving equivalent technical effects made without departing from the principle of the present invention shall also fall within the scope of protection of the present invention.

In the description of the embodiments of the present invention, it should be understood that the indicated orientations or positional relationships are based on the orientations or positional relationships shown in the drawings, or are the conventional orientations or positional relationships when the product of the present invention is used, or are those that are conventionally understood by those skilled in the art, and are merely for the convenience of describing the present invention and simplifying the description, and are not intended to indicate or imply that the referenced device or element must have a particular orientation, be constructed and operated in a particular orientation, and thus should not be construed as limiting the present invention. In the description of the present invention, the term "multiple" and "plurality" means a quantity of two or more, unless otherwise specified.

1. A rolling massager, comprising:
a rod-shaped massager comprising a massage bracket, a massage head assembly, a drive motor, and at least one sensing device;
two handles provided at a left side and a right side of the massage bracket respectively, and
a connecting post disposed between the two handles and connects the two handles;
wherein the massage head assembly comprises two side covers at a left side and a right side of the massage head assembly respectively, and a plurality of connecting shafts; the two side covers rotatably sleeve an outside of the connecting post; two ends of each of the plurality of connecting shafts are connected to the two side covers respectively; each of the plurality of connecting shafts is sleeved by a respective one of a plurality of massage heads; the plurality of connecting shafts and the plurality of massage heads thereon are circumferentially arranged around a circumference of the connecting post and spaced apart from one another; each of the plurality of massage heads is rotatable around a respective one of the plurality of connecting shafts;
an inner circumferential surface of one of the two side covers of the massage head assembly is provided with internal gear teeth; an output end of the drive motor is provided with a reduction gear box; the reduction gear box drives said one of the two side covers containing the internal gear teeth to rotate via a gear transmission assembly, so that the plurality of massage heads revolve around the connecting post;
each sensing device comprises a sensing element and a circuit board electrically connected to each other; at least one of the two handles is provided with a respective one of said at least one sensing devices; the circuit board is also electrically connected to the drive motor.

2. The rolling massager of claim 1, wherein the sensing element is a sensing wire; the circuit board is provided with a touch chip; the touch chip is configured to detect capacitance change of the sensing wire; each of the two handles is provided with a respective sensing device such that there are two sensing devices.

3. The rolling massager of claim 2, wherein an outer side of each of the two handles away from the massage head assembly is shaped to form a gripping portion having a U-shape; the sensing element of each of the two sensing devices is arranged on an inner wall of the gripping portion of a respective one of the two handles.

4. The rolling massager of claim 1, wherein the rolling massager also comprises a support seat;
a left side and a right side of the support seat are raised platforms respectively;
each of the raised platforms is provided with a handle slot wherein a respective one of the two handles of the massage bracket is placed; in between the raised platforms is an operation area in which the massage head assembly is positioned and rotates therein;
at least one of the raised platforms corresponding to said at least one of the two handles provided with the respective one of said at least one sensing devices is provided with a magnet, and said at least one of the two handles provided with the respective one of said at least one sensing devices is also provided with at least one Hall sensor;
said at least one Hall sensor is electrically connected to the circuit board; when the rod-shaped massager is placed on the support seat, the magnet is placed proximal to said at least one Hall sensor and thus triggers said at least one Hall sensor.

5. The rolling massager of claim 4, wherein each of the raised platforms is provided with said magnet.

6. The rolling massager of claim 4, wherein a battery electrically connected to the drive motor is provided inside the connecting post; an inner side of an end of said at least one of the two handles provided with the respective one of said at least one sensing devices is provided with the circuit board, on which a charging connector electrically connected to the battery is installed; on the circuit board, two of said at least one Hall sensor are installed above and below the charging connector respectively, so that there are two Hall sensors; the charging connector is provided with a charging port exposed at a middle part of an end surface of a respective one of the two handles provided with the charging connector; a height of a slot wall of the handle slot of a respective one of the raised platforms corresponding to the respective one of the two handles provided with the charging connector does not exceed a bottom side of the charging port, and the magnet is installed inside the slot wall of the handle slot of the respective one of the raised platforms.

7. The rolling massager of claim 4, wherein one of said at least one of the two handles provided with the respective one of said at least one sensing devices is also provided with an adjustment board electrically connected to the circuit board of said respective one of said at least one sensing devices; the adjustment board is provided with a power switch and an adjustment switch.

8. The rolling massager of claim 1, wherein the connecting post is provided with an installation space, in which the drive motor is installed; the drive motor drives said one of the two side covers containing the internal gear teeth to rotate, thereby driving the massage head assembly to rotate.

9. The rolling massager of claim 8, wherein the installation space is also provided with the gear transmission assembly, which comprises a drive gear and two transmission gears; the drive gear is coaxially connected to an output end of the reduction gear box; the two transmission gears are symmetrically meshed with two sides of the drive gear, and the two transmission gears partially extend out of two side wall openings of the installation space respectively to mesh with the internal gear teeth of said one of the two side covers containing the internal gear teeth.

10. The rolling massager of claim 8, wherein one end of the connecting post is integrally connected to one of the two handles, and another end of the connecting post is detachably connected to a connecting rotating shaft and a handle reinforcing member; the handle reinforcing member is configured to install another one of the two handles; the connecting rotating shaft is hollow.
